(19) United States
(12) Patent Application Publication
(10) Pub. No.: US 2012/0013531 A1
(43) Pub. Date: Jan. 19, 2012

(54) Pressure Sensitive, Ergonomic Mouse

(76) Inventor: Sean Wilson, Fairfax, VA (US)

(21) Appl. No.: 12/835,312

(22) Filed: Jul. 13, 2010

(51) Int. Cl. G06F 3/033

(52) U.S. Cl. 345/163

(57) ABSTRACT

In an embodiment of the present invention, there is disclosed a computer mouse for moving a curser on a computer screen where the computer mouse has a pressure sensitive curser control on its bottom surface which is removably or permanently attached to a vertical or horizontal leg of a support member and where a user, by applying a force to the attached computer mouse to urge the mouse to move in a desired direction will cause the curser on the computer screen to move in that direction. A cushion or a pad is attached to the other leg of the support member for providing support for a user's hand, wrist or arm.

### BACKGROUND OF THE INVENTION

1. Field of the Invention

The present invention relates to a mouse for use with a computer and, more specifically to a computer mouse that eliminates repetitive motion in a user's hand, wrist, and arm which is the cause of carpel tunnel syndrome. The computer mouse is fixed in position to a bracket in either a horizontal or a vertical position at a height that is determined by the user and includes on its bottom surface a pressure sensitive curser control where a user, by applying a slight force to the computer mouse to urge it to move in a desired direction, will cause the curser on the computer screen to move in that direction without requiring the user to actually move the mouse.

2. Description of Related Art

An increase in the use of computer mice with computers has resulted in an increased number of repetitive motion disorders. Typically a user moves a mouse using two fingers and a wrist motion to move a curser and to click and drag an image on the screen. The mouse is normally gripped under the user's hand and by moving his/her forearm or wrist to move the curser on the screen or to drag a group of words or an image by pressing on a button with his/her fingers. These repetitive actions can cause strain and eventually injury in the user's hand and arm. Computer mice which attempt to diminish the detrimental effects of repetitive hand, wrist and arm motion is known in the prior art. More specifically, by way of example, U.S. Pat. No. 6,377,244 to Reid, et al. discloses a mouse having a boomerang shaped body ergonomically shaped to fit and support the user's hand in a relaxed curled hand position

U.S. Pat. No. 5,894,302 to Scenna, et al. discloses an ergonomic housing for a computer mouse for minimizing repetitive strain injuries where the mouse housing includes a palm support area having a hump which is an asymmetrically skewed bulge about with a user's hand may pivot. The palm support area includes a tapered tail for supporting the hand and wrist off the surface.

U.S. Pat. No. 5,805,142 to Byrne discloses a computer mouse that alerts the operator of the mouse if the gripping pressure that the mouse user is applying to the mouse is excessive.

U.S. Pat. No. 6,489,947 to Hesley, et al. discloses a computer mouse which imitates the natural roll of the hand, the wrist and the forearm. The mouse facilitates two fields of motion. In a first field of motion, the fingers, the hand, and the wrist are used to manipulate the cursor control section while an ergonomic hand support section remains substantially stationary. In a second field of motion, the arm and shoulder are used to move the cursor control section and ergonomic hand support section in unison.

U.S. Pat. No. 6,396,479 to Gordon discloses a mouse having two gripping surfaces; one for receives the thumb and the other the opposing fingers. Indentations in the gripping surfaces help locate the finger tips. Mouse buttons are located in the indentations. The gripping surfaces are inclined toward each other, so that the pinching action to actuate the mouse buttons produces a slight downward force toward a base surface that rests upon and slides over the work surface.

U.S. Pat. No. 6,193,196 to Hesley discloses a mouse which reduces repetitive motions by encouraging the user of the mouse to employ two fields of motion to control the pointing device. The user engages the fingers, the hand, and the wrist to make fine movements while holding the hand support device stationary. The user moves the mouse and the hand support device in unison with the arm and shoulder when making coarse movements.

U.S. Pat. No. 5,726,683 to Goldstein, et al. discloses a computer mouse which allows the operator's hand to remain in a relaxed position in as near a state of repose as possible while operating the mouse.

U.S. Pat. No. 6,879,316 to Kehlstadt, et al. discloses a mouse having a solid elastomeric material mounted over a pressure sensing resistor to transfer a force from the user's finger to the pressure sensitive resistor without visible deformation of the elastomeric material.

U.S. Pat. No. 6,795,058 to Gordon discloses a mouse having a small body that can be gripped in the fingers much like a writing implement or an eraser. A primary switch is located on an angled facet on the top of the mouse. The primary switch is activated by the user's first finger. By locating the primary switch on the angled facet, a user can access the switch. A secondary switch is located on a side of the mouse, and is activated by the user's thumb in a pinching motion between the thumb and second finger.

U.S. Pat. No. 7,006,075 to Olson discloses a mouse having a signaling device that is positioned to accommodate a user's fingers when they are in a relaxed, non-extended state and the user's hand is resting on the mouse. The user may actuate a signaling device by exerting pressure on the signaling device in an upward direction, toward the rear of the mouse, or both.

U.S. Pat. No. 6,828,958 to Davenport discloses a side grip computer mouse having a base; a side wall coupled to the base where the side wall has a substantially circular configuration. Switch means is coupled to the side wall for receiving user inputs from at least one of the fingers of the computer user for generating switch signals.

### SUMMARY OF THE INVENTION

In an exemplary embodiment of the present invention, there is disclosed a computer mouse for moving a curser on a computer screen where the computer mouse has a pressure sensitive curser control on its bottom surface which is attached to a vertical or horizontal leg of a support member and where a user, by applying a slight force to the attached computer mouse to urge the mouse to move in a desired direction will cause the curser on the computer screen to move in that direction. A cushion or a pad is attached to the other leg of the support member for providing support for a user's hand, wrist or arm.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a top view of a computer mouse in accordance with the principles of the invention;

FIG. 2 shows a front view of the computer mouse of FIG. 1;

FIG. 3 shows a switch which can be used in the computer mouse;

FIG. 4 shows a computer mouse attached to an adjustable vertical support member and located slightly above a cushion or pad support in accordance with the principles of the invention;

FIG. 5 shows a front view or the computer mouse attached to an adjustable vertical support member of FIG. 4; and

FIG. 6 shows another embodiment of the invention where a computer mouse is attached to a horizontal support member and aligned with or located slightly below a hand or arm cushion or pad support member in accordance with the principles of the invention;

### DESCRIPTION OF THE PREFERRED EMBODIMENT

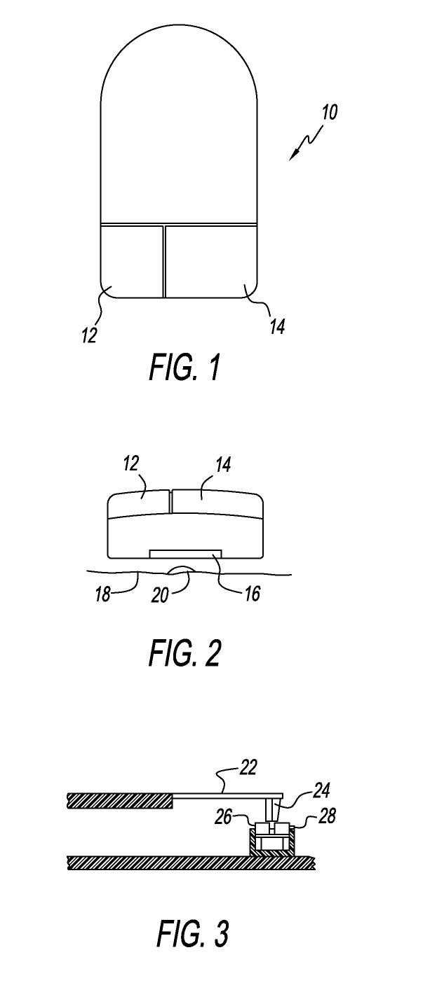

FIG. 1 illustrates the top view of a mouse 10 in accordance with the invention. Switches 12 and 14 perform the standard functions of a computer mouse. Pressure sensitive curser control 16 which is located at the bottom of the mouse and is attached to a fixed support member 18 with, for example with a suction cup 20, is connected to move the curser on a computer screen up, down, left, and right when a force is applied to the pressure sensitive curser control by a user in gripping and urging the mouse to move in a desired direction. Thus, when a left or right force is applied to the pressure sensitive curser control by urging the mouse to move to the left or right, the curser on the screen of the computer will move to the left or right. In a similar manner, the curser can be moved up or down or at an angle across the screen by urging the mouse to move in the desired direction. The use of a pressure sensitive curser control to move a curser on a screen is known by one having ordinary skill in the joy stick art.

FIG. 3 illustrates details of switch 12 of FIG. 1 wherein FIG. 1 switch 14 is similar in design. In FIG. 3, Switch arm 22 is adapted to pivot downward from the top of the mouse. As switch arm 22 pivots downward, plunger 24 makes contact with electrodes 26 and 28. The face of switch plunger 24 makes contact with electrodes 26 and 28 which completes an electrical circuit between electrodes 26 and 28 and thereby allows for the switch functions of switch 22 to occur.

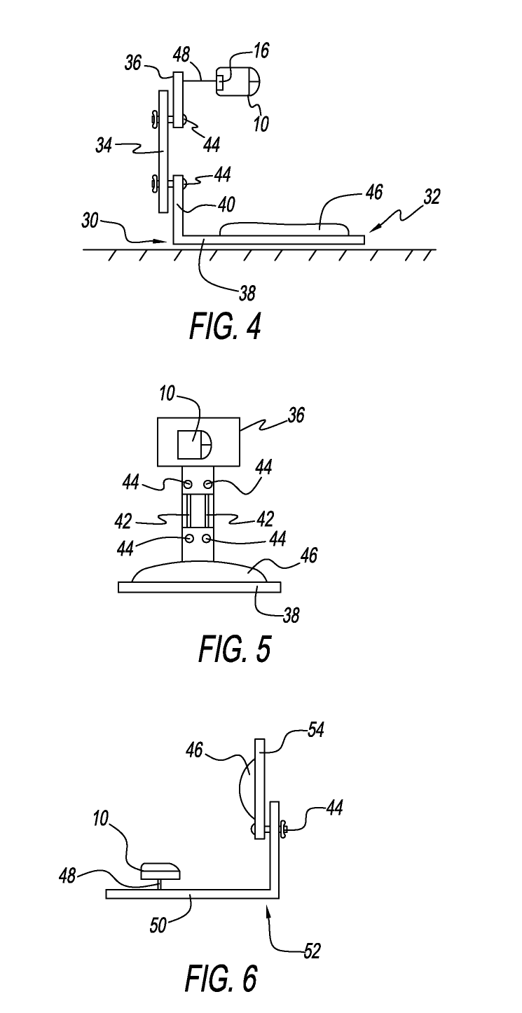

Referring to FIGS. 4 and 5, there is shown a side and front view of a computer mouse having a pressure sensitive curser control non-movably attached to an adjustable vertical support member 30 and located slightly above a hand or arm cushion or pad support member in accordance with the principles of the invention. Adjustable vertical support bracket 30 can be composed of a metal or plastic and can have three cooperating members 32, 34, and 36. Base member 32 can be L shaped having a long horizontal leg 38 and a short vertical leg 40. Member 34 can be a straight intermediate member which connects the short vertical leg 40 to a mouse support member 36. Intermediate member can have two vertically located slots 42 which slidably receive securing bolts 44 used to adjust the height of a mouse attached to the mouse support member relative to a cushion or pad 46.

Two securing bolts 44 pass through clearance openings in the short vertical leg 40 and slots 42 in the intermediate member, and are threaded to thumb tightening nuts which, when tightened, locks intermediate member 34 to the short vertical leg 40. In a similar manner, two securing bolts 44 pass through clearance openings in mouse support member 36 and slots 42 in intermediate member and are threaded to thumb tightening nuts which, when tightened, locks the intermediate member 34 to the mouse support member 36.

The mouse pressure sensitive curser control 16 located on the bottom of the mouse can be securely attached to an outwardly projecting shaft 48, such as a joy stick, which can be permanently or removably attached to the mouse support member 36. The outwardly projecting shaft can be permanently attached to the mouse support member 36 with an adhesive such as an epoxy adhesive, or it can be removably attached to the mouse support member with a suction cup.

To reposition or move the curser on the computer screen, a user simply grasps the mouse and, by applying a slight force to urge the mouse to move in a desired direction, will move the curser on the computer screen to move in that direction.

To use the pressure sensitive curser control, ergonomic mouse, a user rests his/her hand, wrist or arm on the cushion or pad and adjusts the mouse support member 36 to position the mouse to a height where the mouse can be comfortably grasped by the user while his/her hand is supported by the cushion or pad. Now, to move the curser on a computer screen, the user simply applies a slight force to the mouse in the direction that he/she wants to move the curser, and the curser will move. It is to be noted that the mouse yields to an applied force as opposed to being physically displaced, and the user does not repeatedly move his/her hand, wrist and/or arm to move the curser.

The mouse can have any shape and/or size which can be comfortably grasped by a user and, if desired, switches 12, 14 can be pressure sensitive switches which can effectively reduce the distance that a user must move his/her fingers when clicking.

Referring to FIG. 6 there is shown another embodiment of the invention where the pressure sensitive curser control of the computer mouse is permanently or removably attached to a horizontal support member and aligned with or located slightly below a hand or arm cushion or pad support member in accordance with the principles of the invention. In this embodiment the mouse 10 is attached to a horizontal leg 50 of an L bracket 52 having a vertical leg that has two slots for slidably receiving securing bolts 44. A cushion or pad is attached to support member 54 which has two clearance openings for receiving securing bolts. The support member 54 can be mover up or down and locked in position by tightening thumb nuts which are threaded to the securing bolts. In addition, if desired, the mouse can be attached to a plate, not shown, which is slidably attached to the horizontal leg 50 to position the mouse horizontally to control its position relative to the cushion or pad 46.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A pressure sensitive computer mouse for moving a curser on a computer screen comprising:
a support member having a horizontal leg and a vertical leg; and
a computer mouse having a pressure sensitive curser control on its bottom surface which is attached to a leg of the support member;
wherein a user, by applying a slight force to the attached computer mouse to urge it to move in a desired direction will cause the curser on the computer screen to move in that direction.

2. The pressure sensitive computer mouse of claim 1 wherein the pressure sensitive curser control is permanently attached to a leg of the support member.

3. The pressure sensitive computer mouse of claim 2 wherein the other leg of the support member provides support for a user's hand, wrist or arm.

4. The pressure sensitive computer mouse of claim 3 wherein a cushion is located below the computer mouse when the mouse is attached to the vertical leg.

5. The pressure sensitive computer mouse of claim 3 wherein the cushion is aligned with or located above the computer mouse when the mouse is attached to the horizontal leg.

6. The pressure sensitive computer mouse of claim 1 wherein the pressure sensitive curser control is removably attached to a leg of the support member.

7. The pressure sensitive computer mouse of claim 6 wherein the pressure sensitive curser control is removably attached to a leg of the support member with a suction cup.

8. The pressure sensitive computer mouse of claim 1 wherein the pressure sensitive curser control is permanently attached to a shaft which is attached to a leg of the support member.

9. The pressure sensitive computer mouse of claim 8 wherein the pressure sensitive curser control is permanently attached to a shaft which is removably attached to a leg of the support member.

10. The pressure sensitive computer mouse of claim 9 wherein the pressure sensitive curser control is removably attached to a leg of the support member with a suction cup.

11. The pressure sensitive computer mouse of claim 8 wherein the pressure sensitive curser control is permanently attached to a shaft which is permanently attached to a leg of the support member.

12. The pressure sensitive computer mouse of claim 11 wherein the pressure sensitive curser control is permanently attached to a leg of the support member with an epoxy adhesive.

13. The pressure sensitive computer mouse of claim 2 wherein the mouse is ergonomically configured.

14. The pressure sensitive computer mouse of claim 6 wherein the mouse is ergonomically configured.

15. The pressure sensitive computer mouse of claim 2 wherein the pressure sensitive curser control is permanently attached to an adjustable leg of the support member for moving the mouse to a desired position.

16. The pressure sensitive computer mouse of claim 15 wherein the adjustable leg is vertical.

17. The pressure sensitive computer mouse of claim 16 wherein the other leg is horizontal and a cushion or a pad is attached to the horizontal leg of the support member for providing support for a user's hand, wrist or arm.

18. The pressure sensitive computer mouse of claim 2 wherein the pressure sensitive curser control is removably attached to an adjustable leg of the support member for moving the mouse to a desired position.

19. The pressure sensitive computer mouse of claim 2 wherein switches on the mouse can be pressure sensitive switches which reduce the distance that a user must move his/her fingers when clicking.
